(19) United States
(12) Patent Application Publication
(10) Pub. No.: US 2002/0110076 A1
(43) Pub. Date: Aug. 15, 2002

(54) Optical head device

(75) Inventor: Katsushige Yanagisawa, Nagano (JP)

Correspondence Address: SUGHRUE MION, PLLC, 2100 PENNSYLVANIA AVENUE, N.W., WASHINGTON, DC, 20037, US

(73) Assignee: KABUSHIKI KAISHA SANKYO SEIKI SEISAKUSHO

(21) Appl. No.: 10/073,694

(22) Filed: Feb. 14, 2002

(30) Foreign Application Priority Data
Feb. 15, 2001 (JP) P.2001-038304

(51) Int. Cl. G11B 7/135

(52) U.S. Cl. 369/112.24

(57) ABSTRACT

In an optical head device for recording/reproducing information on/from an optical recording medium, a first laser light source emits a first laser light beam having a first wavelength, and a second laser light source emits a second laser light beam having a second wavelength which is different from the first wavelength. An common optical system includes a collimate lens and an objective lens. An optical path composition element directs the first laser light beam and the second laser light beam to the common optical system. A light separating element is disposed between the first laser light source and the optical path composition element, to reflect the first laser light beam toward the optical path composition element, and to pass a light reflected from the optical recording medium to the light receiving element. A relay lens having a positive power is disposed between the second laser light source and the optical path composition element.

### BACKGROUND OF THE INVENTION

The present invention relates to an optical head device which performs recording and reproducing information on optical recording media that are different in recording mode using two kinds of laser light sources emitting laser beams of two kinds of wavelength bands corresponding to the respective optical recording media.

As an optical recording medium, a CD (compact disk), a CD-R (compact disk recordable), and a DVD (digital video disk) are known, which are different in thickness of a substrate and in recording density. To reproduce information from a DVD containing information recorded thereon in high density, it is necessary to use a short-wave laser light having a wavelength of 650 nm or 635 nm. It is a common practice that a laser light having a long wavelength of 760 to 800 nm is used for the CD reproduction. However, the short-wave laser light for the DVD reproduction may be used for the CD reproduction, as a matter of course. The CD-R (recordable) or the CD-RW (rewritable), which is developed on the basis of the CD, is designed so as to produce the maximum performances by using the long wave laser light, which is generally used for CD reproduction. Therefore, to handle both the CD-R and DVD by a single optical head device, it is necessary to install two laser light sources to the device, a first laser light source for emitting a short wave laser light, and a second laser light source for emitting a long wave laser light.

If two separate optical systems are used for the optical head device, the number of optical elements is increased when comparing with the optical head device using a single optical system. Further, the device size is increased, and the device cost is also increased.

Japanese Patent Publication No. 10-199021A discloses an optical head device in which optical paths of the short-wavelength laser beam and the long-wavelength laser beam that are directed toward an optical recording medium are composed by an optical path composition element such as a prism having a partial reflection face.

This kind of optical head device includes, for example, as shown in FIG. 5, a DVD laser diode 104 (first laser light source) that emits a first laser beam L1 (short-wavelength laser beam), and a CD laser diode 105 (second laser light source) that emits a second laser beam L2 (long-wavelength laser beam).

Further, on an optical path extending straight toward an optical recording medium D from the CD laser diode 105, a first prism 110 (diachronic prism; optical path composition element) and a second prism 120 (polarized beam splitter; return light separating element) are placed. A beam emitted from the DVD laser diode 104 is incident on the first prism 110 from the right-angle direction to this optical path. A partial reflection face 111 of the first prism 110 is at an angle of 45° to both an optical axis of the first laser beam L1 emitted from the DVD laser diode 104 and an optical axis of the second laser beam L2 emitted from the CD laser diode 105. The first laser beam L1 emitted from the DVD laser diode 104 and reflected from the partial reflection face 111 of the first prism 110 is guided to a common optical path 130 directed to the optical recording medium D. On the other hand, the second laser beam L2 emitted from the CD laser diode 105 passing through the partial reflection face 111 of the first prism 110 is guided to the common optical path 130 directed to the optical recording medium D.

On this common optical path 130, the first laser beam L1 and second laser beam L2 emerged from the first prism 110 pass through a partial reflection face 121 of the second prism 120. They are incident on a collimator lens (coupling lens) 131, and converted into a parallel luminous flux. After then, they pass through a λ/4 plate 132 and an aperture 133. Thereafter, they are converged on a recording surface of DVD or CD that is an optical recording medium D as a light spot, through an objective lens 134.

Further, beams of the laser beams L1 and L2 that has reflected from the optical recording medium D return to the objective lens 134, the aperture 133, the λ/4 plate 132, and the collimator lens 131, are incident again on the second prism 120. They are reflected from the partial reflection face 121 of this second prism 120, and passes through a sensor lens 141 (cylindrical lens) while generating astigmatism. Finally, they are directed to a light receiving element 142 (optical sensor).

As the magnification of the optical system decreases, its transmission efficiency of light increases. Accordingly, the optical head device has an advantage that a large amount of emitted light is utilized with a light emission of a small amount of light. In recording information on a CD-R, it is necessary to form a spot having a large power, and hence a magnification of the optical system must be selected to be small. In reproducing information from a DVD, it is necessary to form a spot having a small diameter on the optical recording medium D. To this end, it is necessary to increase the magnification of the optical system, and to thereby secure good image formation performance of the optical system.

Accordingly, in the optical head device 100, in a case where the magnification of the optical system is made small in order to increase the optical transmission efficiency, the rim intensity decreases and the imaging power decreases, so that the diameter of the spot formed on the optical recording medium D is made large when the DVD is reproduced.

Therefore, in the optical head device 100 shown in FIG. 5, a relay lens 140 having positive power is placed on the optical path leading to the first prism 110 from the CD laser diode 105 thereby to make small the magnification of the optical system for the second laser beam L2 emitted from the CD laser diode 105 and to make large the magnification of the optical system for the first laser beam L1 emitted from the DVD laser diode 104.

The magnification M1 of the optical system for the laser beam L1 emitted from the laser diode 104 is defined by the ratio of an optical path length in air from the laser diode 104 to the collimator lens 131 (focal length FCL of the collimator lens 131) to an optical path length in air from the objective lens 134 to the recording surface of the optical recording medium D (focal length FOL of the objective lens 134). Namely,

M1=FCL/FOL (1)

On the other hand, the magnification M2 of the optical system for the laser beam L2 emitted from the laser diode 105 is defined by the ratio of a composed focal length FRC of the relay lens 140 and the collimator lens 131 to an optical path length in air from the objective lens 134 to the recording surface of the optical recording medium D (focal length FOL of the objective lens 134). Namely,

M2=FRC/FOL (2)

In a case where the objective lens 134 is used in common, the optical path length in air from the objective lens 134 to the recording surface of the optical recording medium D in the laser diode 104 (laser beam L1) is equal to that in the laser diode 105 (laser beam L2). Therefore, in a case where the magnification M1 of the optical system for the laser beam L1 emitted from the laser diode 104 is made smaller than the magnification M2 of the optical system for the laser beam L2 emitted from the laser diode 105, the composed focal length FRC of the relay lens 140 and the collimator lens 131 becomes smaller than the focal length FCL of the collimator lens 131. Then, the distance from the collimator lens 131 to the laser diode 105 becomes shorter than the distance from the collimator lens 131 to the laser diode 104.

However, since the second prism 120 is placed between the first prism 110 and the collimator lens 131 in the optical head device 100 shown in FIG. 5, so long as the distance from the first prism 110 to the collimator lens 131 is long, a difference must be given to the magnifications of the optical systems in the narrow space from the laser diodes 104,105 to the first prism 110. Accordingly, since the distance between the CD laser diode 105 and the relay lens 140 is very short, the performance of the optical head device 100 varies greatly by the optical characteristics of the relay lens 140. Therefore, the optical head device 100 shown in FIG. 5 does not have enough tolerance for the relay lens 140 itself and tolerance for a assembling position of the relay lens 140, so that it is very difficult to manufacture the optical head device 100.

Further, unevenness in a diverging angle and in magnification of the second laser beam L2 emitted from the relay lens 140, and the axial deviation of the relay lens 140 become aberration and easily appear.

Moreover, the grating for three-beam formation is generally arranged in relation to the second laser beam L2 emitted from the CD laser diode 105. However, it is difficult from a viewpoint of space to arrange this grating between the CD laser diode 105 and the first prism 110 together with the relay lens 140.

These problems will be explained below using mathematical expressions.

Firstly, the accuracy of the magnification will be calculated, and the accuracy of the relay lens 140 itself and the built-in accuracy of the relay lens 140 in the direction of an optical axis will be considered.

In connection with the optical systems before and behind the relay lens 140, FIG. 6 shows a case where the relay lens 140 is provided, which exactly represents the optical system for the laser beam L2 emitted from the laser diode 105, and FIG. 7 shows a case where the relay lens 140 is omitted, which exactly represents the optical system for the laser beam L1 emitted from the laser diode 104. Here, the difference between the magnification M1 of the optical system for the laser beam L1 emitted from the laser diodes 104 and the magnification M2 of the optical system for the laser beam L2 emitted from the laser diodes 105 is produced by the existence of the relay lens 140. Therefore, the magnification MR of the relay lens 140 can be represented by the ratio of the magnification M1 to the magnification M2 as follows:

MR=M1/M2 (3)

In case of M1>M2, MR is lager than 1.

Further, in FIG. 6, an object distance S2 of the relay lens 140 is a length from a principal point H of the relay lens 140 to a light emission point P2 of the laser diode 105. Further, an image distance S1 is a distance from the principal point H of the relay lens 140 to an image point P1. In a case where the distance between the principal points of the relay lens 140 is ignored, the image point P1 coincides with a light source position P1′ in FIG. 7. At this time, the magnification of the relay lens 140 is represented by the following expression:

MR=S1/S2 (4)

When a focal length of the relay lens 140 is given as FRL, the following expression is obtained from an image formula of lens:

1/S2=1/S1+1/FRL (5)

The expressions (4) and (5) are rearranged by differentiation as follows:

ΔMR=ΔS1/S1²−ΔFRL/FRL² (6)

ΔS1 in the expression (6) represents the built-in accuracy of the relay lens 140 in the direction of the optical axis, and ΔFRL represents the accuracy of the focal length of the relay lens.

In a case where the relay lens 140 is close to the light source like the optical head device shown in FIG. 5, a value of S1 in the above expression becomes small. Further, as clear from the expression (4), a value of S2 becomes also small. When values of S1 and FRL in the expression (6) become small, unless values of ΔS1 and ΔFRL are made small in proportion to their square, the desired magnification accuracy ΔMR cannot be obtained. Namely, the tolerance in relation to the built-in accuracy and the accuracy of the focal length of the relay lens 140 is eliminated.

Further, when the focal length FRL of the relay lens 140 is small, a radius of a lens surface of the relay lens 140 becomes small. Therefore, it is difficult to manufacture the relay lens 140. Further, when the radius of the lens surface is small, the small unevenness of the lens surface has a great influence on the focal length FRL. Therefore, it is also hard to obtain the accuracy of the relay lens 140 itself, so that it is difficult to manufacture the relay lens 140.

Next, the built-in accuracy of the relay lens 140 in the direction orthogonal to the optical axis will be considered.

When the built-in accuracy of the relay lens in the direction orthogonal to the optical axis is given as ΔY2 as shown in FIG. 8, the light source produces an object height ΔY2 in relation to the relay lens 140, and an image height ΔY1 is represented by ΔY1=MR·ΔY2. When an angle made by the lens optical axis and a principal axis leading to the image height ΔY1 is given as θ,

Δθ=ΔY2/S2=ΔY1/S1 (7)

The aberration of the lens has the image height characteristic, and comatic aberration and astigmatism are produced in accordance with Δθ.

In a case where the relay lens 140 is close to the light source like the optical head device shown in FIG. 5, values of S1 and S2 in the above expression become small. Therefore, unless values of ΔY1 and ΔY2 are made small in proportion to the values of S1 and S2, the value of Δθ becomes large, so that the aberration is produced. Further, Δθ becomes also the image height of the collimator lens 131 and the objective lens 134 after the relay lens 140, so that production of aberration in their optical systems becomes also large.

### SUMMARY OF THE INVENTION

It is therefore an object of the invention is to provide an optical head device which performs recording and reproduce information on optical recording media that are different in recording mode using two kinds of laser light sources that emit laser beams of two kinds of wavelength bands, wherein problems on layout and on aberration are eliminated while providing the difference to the magnifications of optical systems for the two kinds of laser beams.

In order to achieve the above object, according to the present invention, there is provided an optical head device for recording/reproducing information on/from an optical recording medium, comprising:

a first laser light source for emitting a first laser light beam having a first wavelength;

a second laser light source for emitting a second laser light beam having a second wavelength which is different from the first wavelength;

an common optical system including a collimate lens and an objective lens;

a light receiving element;

an optical path composition element, which directs the first laser light beam and the second laser light beam to the common optical system;

a light separating element disposed between the first laser light source and the optical path composition element, which reflects the first laser light beam toward the optical path composition element, and passes a light reflected from the optical recording medium to the light receiving element; and

a relay lens having a positive power, and disposed between the second laser light source and the optical path composition element.

Since it is preferable that the magnification of the optical system is larger for the first laser light emitted from the first light source, the light separating element is disposed on the optical path ranging from the first light source to the optical path composition element. On the other hand, since it is preferable that the relay lens is disposed between the second light source and the optical path composition element for the second laser light emitted from the second light source, thereby reducing the magnification of the optical system. The light separating element is not disposed between the second light source and the optical path composition element. Accordingly, even if the relay lens is disposed between the second light source and the optical path composition element, a relatively long distance is secured between the relay lens and second light source. Therefore, if the optical characteristics of the relay lens are a little varied, the performances of the optical head device are not degraded. Relatively large tolerances are set up for the accuracy of the relay lens per se and the accuracy of the assembling position of the relay lens. Variations of the divergent angle of the second laser light emitted from the relay lens and variations of the magnification, and the axis offset of the relay lens hardly appear in the form of the aberration. Therefore, in the optical head device of the type in which information is recorded into and reproduced from optical recording mediums having different recording modes by correspondingly using two laser light sources for emitting laser lights having different wavelengths, if the magnification of the optical system for the first laser light is made different from that for the second laser light by using the relay lens, no problem arises in the layout and aberration.

Moreover, since the converged light is incident on the optical path composition element, the angle dependency tolerance is larger than in the optical arrangement where the diverging light is incident on the optical path composition element. Therefore, extremely high accuracy is not required for the relay lens. Further, extremely high assembling accuracy is not required when the optical head device is assembled. Further, since the greatly thick optical path composition element may be used, the relay lens having stable optical characteristics may easily be manufactured.

Preferably, the first laser light beam is used for recording/reproducing information on/from a digital video disk, and the second laser light beam is used for recording/reproducing information on/from a compact disk.

Preferably, the optical path composition element is a prism having a partial reflection face, and the light separating element is a half mirror having a partial reflection face.

In the invention, the optical path composition element is, for example, a prism having a partial reflection face, and the return light separating optical element is, for example, a half mirror having a partial reflection face.

Preferably, the optical head device further comprises a grating element disposed between the second laser light source and the relay lens.

Since a sufficient distance is secured between the relay lens and the second light source three beams are stably formed.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a plan view of a main part of an optical head device according to one embodiment of the invention;

FIG. 2 is a schematic cross sectional view of the optical head device taken on line A-A′ in FIG. 1;

FIG. 3 is a schematic cross sectional view of the optical head device taken on line B-B′ in FIG. 1;

FIG. 4 is a plan view of a main part of an optical head device as a comparative example;

FIG. 5 is a plan view of a related optical head device; and

FIGS. 6 to 8 are diagrams for explaining problems in the related optical head device.

### DETAILED DESCRIPTION OF THE PREFERRED EMBODIMENTS

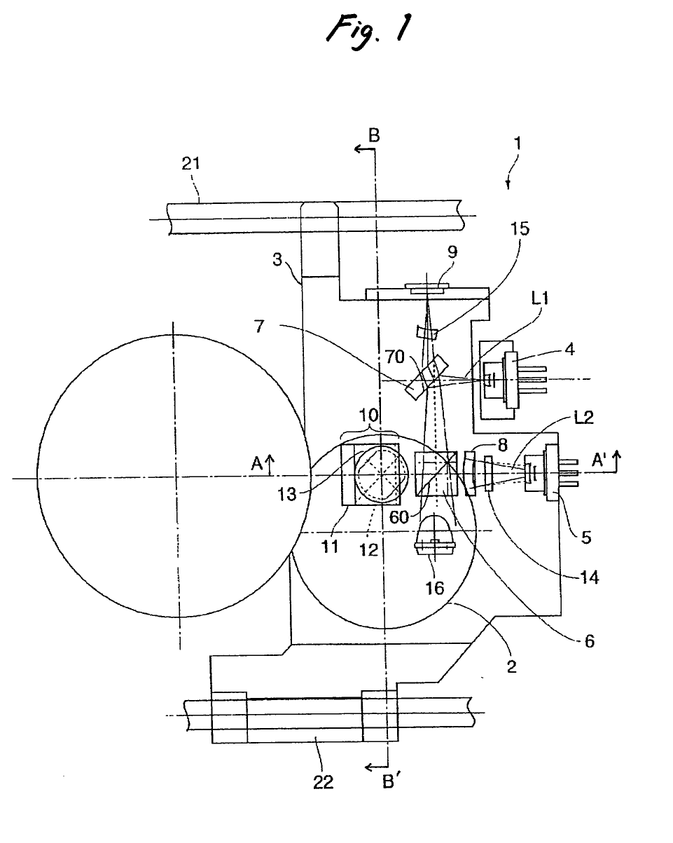

An optical head device according to one embodiment of the present invention will be described with reference to FIGS. 1 to 3. The optical head device is used for recording information to and reproducing the same from CD, CD-R, and DVD.

In this embodiment, an optical head device 1 includes a base 3. This base 3 is slidable along two parallel guide shafts 21 and 22, which are mounted on a device frame (not shown). An optical system to be described hereunder is arranged on the base 3.

In the optical head device 1, the optical system includes a laser diode (a first laser light source) 4 for emitting a first laser light (short wave laser light) L1 for DVDs and a laser diode (a second laser light source) 5 for emitting a second laser light (long wave laser light) L2 for CDs. The first light source 4 is used for recording and reproducing information from a DVD, and emits the first laser light L1 having a wavelength of 650 nm. The second light source 5 is used for recording and reproducing information from a CD and CD-R, and emits the first laser light having a wavelength of 785 nm.

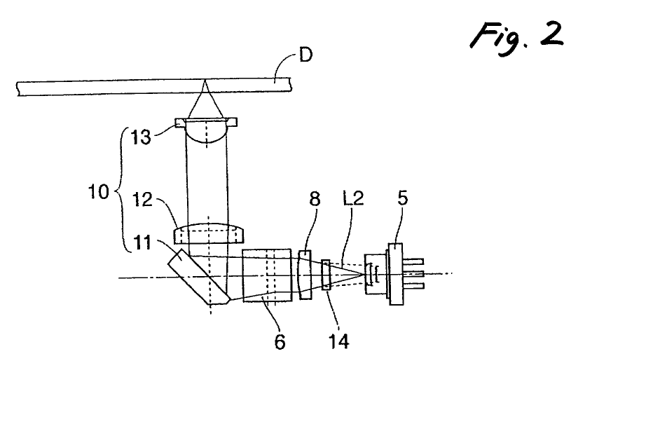

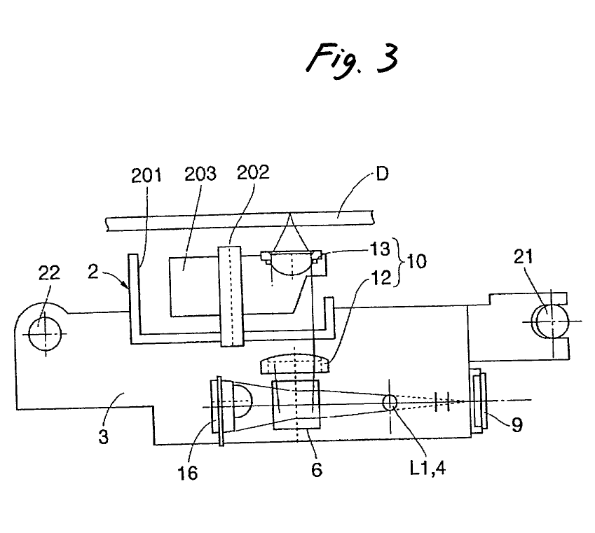

As shown in FIG. 2, the first laser light L1 emitted from the first light source 4 and the second laser light L2 emitted from the second light source 5 are guided, by a prism 6 serving as an optical path composition element, to a common optical path 10 destined for an optical recording medium D. A mirror 11, a collimate lens 12 and an objective lens 13 are disposed in this order on the common optical path 10. As shown in FIG. 3, of those optical elements, the objective lens 13 is mounted on a lens holder 203 of a lens driver 2. The lens holder 203 is slidably and rotatably supported on a supporting shaft 202 of a holder support 201.

In the optical head device 1, to guide the first laser light L1 emitted from the first light source 4 and the second laser light L2 emitted from the second light source 5 to the common optical path 10, a half mirror 7 serving as a light separating element is disposed on the optical path ranging from the second light source 5 to the optical recording medium. The half mirror 7 partially reflects the second laser light L2 emitted from the second light source 5 toward the prism 6, and allows a return light from the optical recording medium to partially pass therethrough so that the return light is directed to the light receiving element 9. A grating lens 14 is disposed on an optical path ranging from the second light source 5 to the prism 6. A light receiving element 16 used for the monitoring purpose is disposed at the side of the prism 6, which is opposed to the half mirror 7 side.

The half mirror 7 is disposed such that a partial reflection face 70 thereof is inclined relative to the optical axis of the first laser light L1 emitted from the first light source 4 at an angle of 45 degrees. The prism 6 is disposed such that a partial reflection face 60 thereof is inclined relative to the optical axes of the laser light L1 and L2 emitted from the laser diodes 4 and 5 at an angle of 45 degrees.

The grating element 14 is provided with predetermined diffraction characteristics, and splits the second laser light L2 emitted from the second light source 5 into three beams. Specifically, the second laser light L2 used for recording and reproducing information from a CD and CD-R is split into three beams by the grating element 14, whereby a known three-beam method is performed to detect tracking errors.

In recording information on a CD-R, it is necessary to form a spot having a large power, and hence a magnification of the optical system must be selected to be small. As the magnification of the optical system decreases, its transmission efficiency of light increases. Accordingly, the optical head device has an advantage that a large amount of emitted light is utilized with a light emission of a small amount of light. In reproducing information from a DVD, it is necessary to form a spot having a small diameter on the optical recording medium D. To this end, it is necessary to increase the magnification of the optical system, and to thereby secure good image formation performance of the optical system.

A relay lens 8 having a positive power is disposed between the grating lens 14 and the prism 6 on the optical path ranging from the second light source 5 to the prism 6. With provision of the relay lens 8, the magnification of the optical system, which is for converging the second laser light L2 emitted from the second light source 5 into a spot on the optical recording medium D, is selected to be small, i.e., within a range of 3.5 to 4.5 times. On the other hand, the magnification of the optical system, which is for converging the first laser light L1 emitted from the first light source 5 into a spot on the optical recording medium D, is selected to be large, i.e., within a range of 6.5 to 7.5 times.

The first laser light L1 as emitted from the first light source 4 is incident on the half mirror 7, and a light component of 20-80% of the incident laser light is reflected by the partial reflection face 70. The optical axis of the thus reflected laser light is curved by 90 degrees so that it is directed to the prism 6. A light component of 50% or more the laser light L1 incident on the prism 6 is reflected by the partial reflection face 60. The optical axis of the thus reflected laser light is curved by 90 degrees so that it is directed to the mirror 11 on the common optical path 10 so as to be reflected toward the collimate lens 12.

On the other hand, the second laser light L2 emitted from the second light source 5 passes through the grating element 14, and then through the relay lens 8 having a positive power, and is incident on the prism 6. A light component of 75-95% of the second laser light L2 that is incident on the prism 6 passes through the partial reflection face 60 to the mirror 11 on the common optical path 10; and it is reflected upward by the mirror 11 and then is incident on the collimate lens 12.

The second laser light L2 thus guided to the collimate lens 12 is converted into a collimated light beam, guided to the objective lens 13, and converged into a light spot on the recording face of the CD as an optical recording medium D, by the objective lens 13. Accordingly, a light component of approximately 90% of the second laser light L2 emitted from the second light source 5 is guided to the recording surface of CD or CD-R as the optical recording medium D.

The laser light beams L1 and L2 as reflected by the optical recording medium D travels back through the objective lens 13, the collimate lens 12 and the mirror 11, and reaches the prism 6.

A light component of not less than 50% of the first laser light L1 for DVD is reflected by the partial reflection face 60 of the prism 6, and the optical axis of the thus reflected laser light is curved by 90 degrees so that it is directed to the half mirror 7. A light component of 20-80% of the thus reflected laser light L1 passes through the partial reflection face 70 of the half mirror 7, and is incident on a sensor lens 15. Then it passes through the sensor lens 15 and reaches the light receiving element 9.

On the other hand, a light component of 5-30% of the second laser light L2 for CD is reflected by the partial reflection face 60 of the prism 6, and the optical axis of the reflection laser light is curved by 90 degrees so that it is directed to the half mirror 7. A light component of not less than 30% of the thus reflected second light L2 passes through the partial reflection face 70 of the half mirror 7 so that it is incident on the sensor lens 15, and passes through the sensor lens 15 and reaches the light receiving element 9.

The sensor lens 15 is a lens for generating an astigmatism for both the laser lights L1 and L2. With the use of the sensor lens, the return lights of the first laser light L1 for DVDs and the second laser light L2 for CDs undergo when those lights pass through the sensor lens 15. Accordingly, as well known, when the quadrant photodetective elements are provided with the sensor lens 15, the focusing correction may be made by using the amounts of photo-current output from those elements.

As described above, although information is recorded on and reproduced from optical recording mediums whose recording modes are different, such as CD, CD-R and DVD, through use of two diodes 4 and 5 for DVD and CD, and CD-R, there is no need of providing optical systems respectively for the diodes 4 and 5 since the common optical path 10 is formed by using the mirror 11, the collimate lens 12 and the objective lens 13. Accordingly, the number of optical elements forming the optical system is remarkably reduced. Further, parts and assembling costs may be reduced, so that an inexpensive optical head device 1 is realized. Additionally, an area occupied by the optical system is reduced by the amount corresponding to the reduced number of necessary optical elements. This makes the optical head device 1 compact. For this reason, the optical head device 1 may be incorporated into a notebook model PC which is able to handle the optical recording mediums of different recording modes, such as CD-R and DVD.

In the optical head device 1 of the instant embodiment, to guide the first laser light L1 emitted from the first light source 4 and the second laser light L2 emitted from the second light source 5 to the common optical path 10, since it is preferable that the magnification of the optical system is larger for the first laser light L1 emitted from the first light source 4. Therefore, the half mirror 7 (light separating element) is disposed on the optical path ranging from the first light source 4 to the prism 6. On the other hand, since it is preferable that a relay lens 8 having a positive power is disposed between the second light source 5 and the prism 6 for the second laser light L2 emitted from the second light source 5, thereby reducing the magnification of the optical system. The half mirror 7 is not disposed between the second light source 5 and the prism 6. Accordingly, even if the relay lens 8 having a positive power is disposed between the second light source 5 and the prism 6 for the second laser light L2 emitted from the second light source 5, a relatively long distance is secured between the relay lens 8 and second light source 5. Therefore, if the optical characteristics of the relay lens 8 are a little varied, the performances of the optical head device 1 are not degraded. Relatively large tolerances are set up for the accuracy of the relay lens 8 per se and the accuracy of the assembling position of the relay lens 8. Variations of the divergent angle of the second laser light L2 emitted from the relay lens 8 and variations of the magnification, and the axis offset of the relay lens 8 hardly appear in the form of the aberration. Therefore, in the optical head device 1 of the type in which information is recorded into and reproduced from optical recording mediums having different recording modes by correspondingly using two different laser diodes (laser light sources) for emitting laser lights L1 and L2 having different wavelengths, If the magnification of the optical system for the first laser light L1 is made different from that for the second laser light L2 by using the relay lens 8, no problem arises in the layout and aberration.

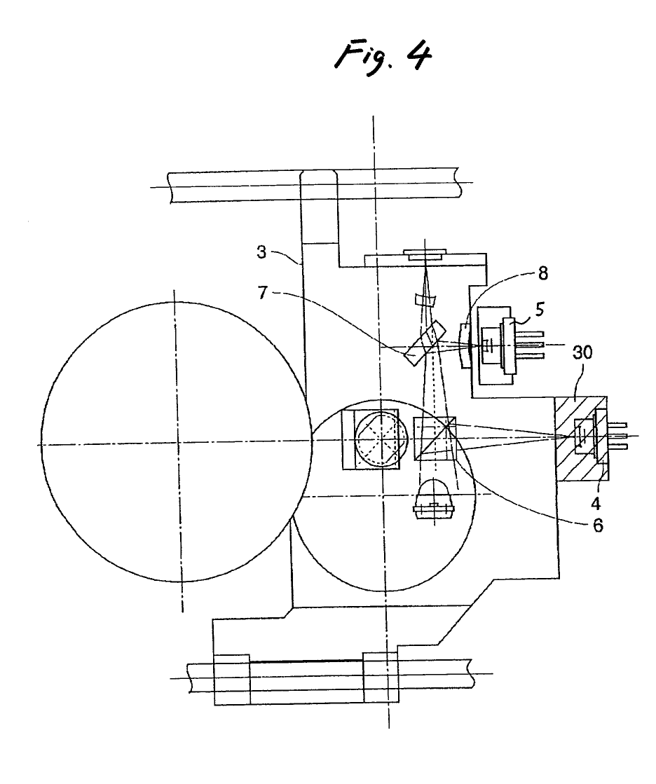

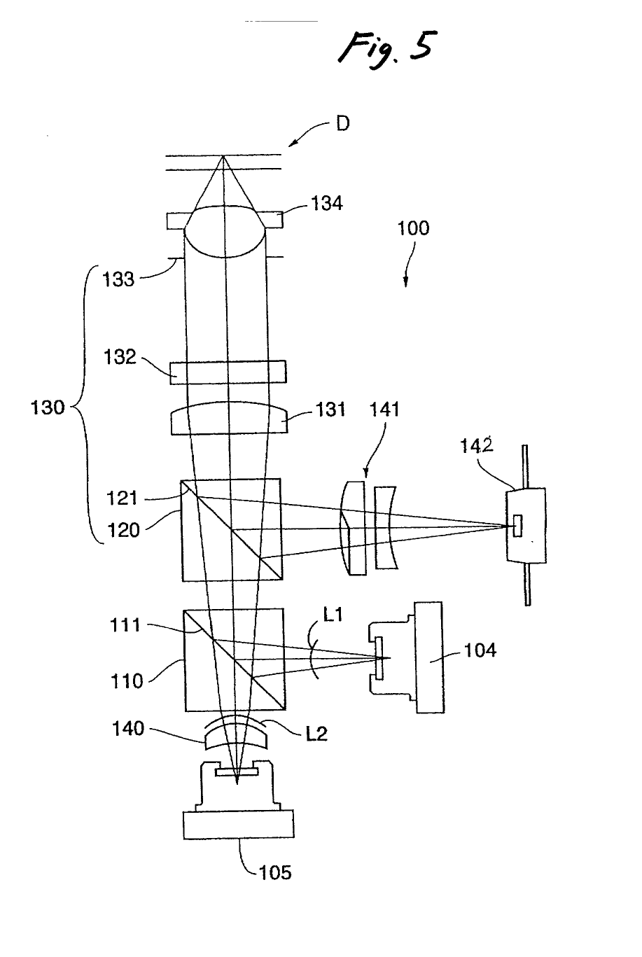

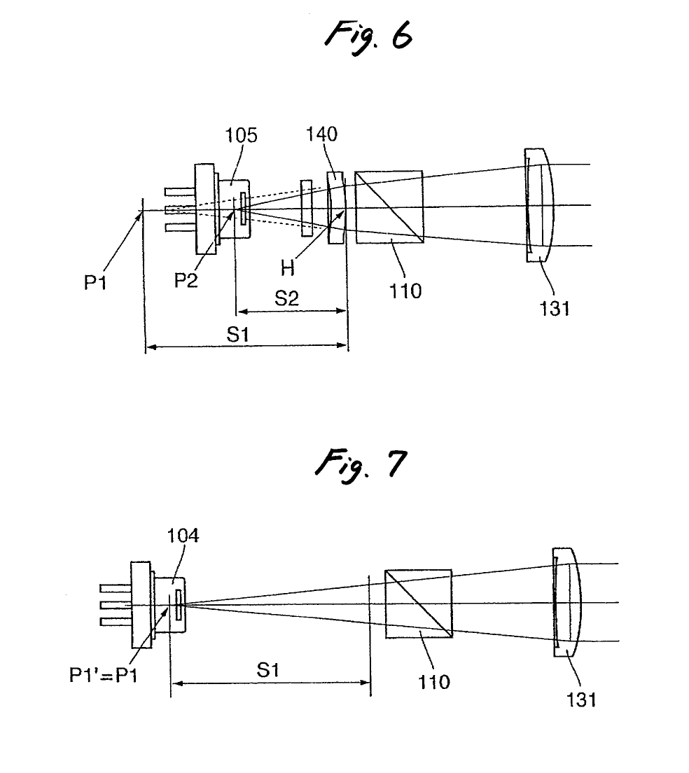

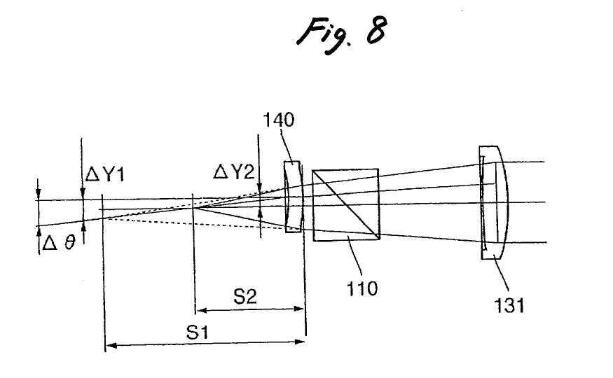

A sufficient space for disposing the relay lens 8 and the grating element 14 is secured between the second light source 5 and the prism 6. Here, the relay lens 8 and the grating element 14 are inevitably disposed in a narrow space between the second light source 5 and the half mirror 7, as shown in FIG. 4, it is evident that such a layout of the optical elements is spatially difficult. Moreover, the first laser light L1 of which the magnification of the optical system must be selected to be large, is directly incident on the prism 6, from the first light source 4. As a result, a distance between the first light source 4 and the prism 6 is relatively long, and the base 3 must be large in size. The optical head device 1 of the instant embodiment is free from such problems.

In the embodiment, when the relay lens 8 and the grating element 14 are disposed between the second light source 5 and the prism 6, the grating element 14 is disposed between the second light source 5 and the relay lens 8. Accordingly, a sufficient distance is secured between the relay lens 8 and the second light source 5 when comparing with the case where the grating element 14 is disposed between the prism 6 and the relay lens 8.

Furthermore, a sufficient distance is secured between the second light source 5 and the grating element 14. Accordingly, three beams are stably formed.

In the embodiment, in creating a predetermined difference between the magnification for the first laser light L1 and that for the second laser light L2, the relay lens 8 having a positive power is provided for the second laser light L2 for which decrease of the magnification of the optical system is required, unlike the optical arrangement in which the relay lens having a negative power is provided for the first laser light L1 for which decrease of the magnification of the optical system is required. Accordingly, the converged light is incident on the prism 6. For this reason, in the optical arrangement of the instant optical head device, the angle dependency tolerance is larger than in the optical arrangement where the diverging light is incident on the prism 6. Therefore, extremely high accuracy is not required for the relay lens 8. Further, extremely high assembling accuracy is not required when the optical head device 1 is assembled. Further, since the greatly thick prism 6 may be used, the relay lens 8 having stable optical characteristics may easily be manufactured.

Additionally, in the instant embodiment, the light directed to the optical recording medium D, rather than the return light, is preferentially handled so that a light component of 90% or higher of the second laser light L2 emitted from the second light source 5 is reflected by the partial reflection face 60 of the prism 6, and is guided to the common optical path 10. Therefore, a light spot having a high power enough to record information on the CD-R may be formed.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. An optical head device for recording/reproducing information on/from an optical recording medium, comprising:
a first laser light source for emitting a first laser light beam having a first wavelength;
a second laser light source for emitting a second laser light beam having a second wavelength which is different from the first wavelength;
an common optical system including a collimate lens and an objective lens;
a light receiving element;
an optical path composition element, which directs the first laser light beam and the second laser light beam to the common optical system;
a light separating element disposed between the first laser light source and the optical path composition element, which reflects the first laser light beam toward the optical path composition element, and passes a light reflected from the optical recording medium to the light receiving element; and
a relay lens having a positive power, and disposed between the second laser light source and the optical path composition element.

2. The optical head device as set forth in claim 1, wherein the optical path composition element is a prism having a partial reflection face, and the light separating element is a half mirror having a partial reflection face.

3. The optical head device as set forth in claim 1, further comprising a grating element disposed between the second laser light source and the relay lens.

4. The optical head device as set forth in claim 1, wherein the first laser light beam is used for recording/reproducing information on/from a digital video disk, and the second laser light beam is used for recording/reproducing information on/from a compact disk.
